(19) United States
(12) Patent Application Publication
(10) Pub. No.: US 2003/0053209 A1
(43) Pub. Date: Mar. 20, 2003

(54) Dual stage optical isolator with reduced polarization mode dispersion and beam offset

(75) Inventors: Kok-Wai Chang, Los Altos, CA (US); Qiaomei Cheng, San Ramon, CA (US)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(73) Assignee: JDS UNIPHASE CORPORATION

(21) Appl. No.: 10/245,745

(22) Filed: Sep. 18, 2002

Related U.S. Application Data
(60) Provisional application No. 60/323,110, filed on Sep. 19, 2001.

(51) Int. Cl. G02B 5/30

(52) U.S. Cl. 359/484; 359/497; 359/499; 372/703

(57) ABSTRACT

A double-stage (multi-stage) optical isolator is composed of two pairs of birefringent wedges (polarizers) with a Faraday rotator sandwiched by a pair of the wedges. The wedge-shaped polarizers, each defining a wedge angle, are disposed such that the wedges of the third and fourth polarizer (second stage) are arranged generally opposite relative to the wedges of the first and second polarizer (first stage) respectively, the wedge angles and the angles of incidence in the forward direction selected such as to minimize offset between the line of propagation of an optical beam passing through the isolator in the forward direction. The isolator has a PMD compensation element disposed between the first and the second stage to minimize polarization mode dispersion of light beams propagating through the isolator. The isolator has a very low PDL, virtually no PMD, high isolation and virtually no displacement (offset) between the input beam and out beam line of propagation.

### RELATED APPLICATIONS:

This application claims priority from U.S. provisional application No. 60/323,110 filed Sep. 19, 2001, the provisional application to be incorporated by reference therewith in its entirety.

### TECHNICAL FIELD

This invention relates to optical isolators, and more specifically, to multi-stage isolators, especially such isolators with provisions for reducing polarization mode dispersion (PMD).

### BACKGROUND ART

Optical isolators are among the most ubiquitous passive components found in optical communication systems. Optical isolators are used to allow signals to propagate in a forward direction but not in a backward direction. They are often used to prevent unwanted back-reflections from being transmitted back to the signal's source. It is generally known that in optical isolators utilizing birefringent elements, for example birefringent wedges, polarization mode dispersion (PMD) typically takes place causing, unless compensated, problems with the quality of optical signals.

These problems have already been addressed in the patent literature. For example, in U.S. Pat. No. 5,557,692, now assigned to the present assignee, Pan et al. disclose a single-stage optical isolator having a first birefringent polarizer, a Faraday rotator and a second polarizer (called also an analyzer) and having a PMD compensating birefringent plate with selected refractive indices and a thickness to compensate for the difference in optical distance travelled by the two rays, o-ray and e-ray (ordinary and extraordinary) produced by the birefringence of the polarizers. The PMD plate is disposed either adjacent to the rotator, or adjacent to one of the polarizers. The arrangement reduces a so-called “walk-off” i.e. the difference in the displacement of the e-ray and o-ray from the original line of propagation of the beam of light incident on the device. As known, the “walk-off” contributes to the polarization mode dispersion in the isolator.

It should be noted that the displacement of both rays from the original line of propagation of the incident beam of light (herein termed “input line of travel”) likely predetermines the size of the device as the elements must be selected to accommodate the lateral displacement of the rays from the incident line of travel, otherwise the rays in the forward direction would run out of the device.

U.S. Pat. Nos. 5,566,259 and 5,581,640 to Pan et al., both assigned to the present assignee, address PMD compensation in multi-stage isolators. In both cases, the isolator has two stages, each stage having two polarizers sandwiching a Faraday rotator. According to the '259 patent, the PMD is reduced by arranging the optical axes of the polarizers of the second stage such that a polarization mode along one direction of light in the first stage is aligned along the opposite direction in the second stage and vice versa. In this way, equalization of the optical paths of the e-ray and o-ray is intended. The '640 patent proposes to arrange the birefringent polarizers and Faraday rotators of both stages in a single magnet to reduce the sensitivity of the isolator to wavelength changes.

It is noted that the '259 patent does not illustrate specifically the arrangement of the birefringent wedges in both isolator stages. However, the '640 patent, in FIGS. 6a and 6b, shows a typical arrangement of the main elements of the isolator in that both stages (or multiple stages) are made up of geometrically identical wedge configurations. This results in a relatively large offset between the input line of travel, as explained above, and the output line of travel of the isolator in the forward direction, since the offsets add over two or more identical stages. The walk-off is a function of the wedge angle, wedge thickness and garnet (Faraday rotator) thickness. Typical walk-off for 12 degree wedge based core is 165 μm and 290 μm for a dual stage core.

Other isolator designs are shown e.g. in U.S. Pat. No. 5,208,876 (Pan), U.S. Pat. No. 5,559,633 (Emkey), U.S. Pat. No. 6,091,866 (Cheng) and U.S. Pat. No. 6,288,826 (Wills).

While all the above-noted designs have merit, there is still a need to provide a multi-stage, minimum two-stage optical isolator with reduced PMD, high isolation and reduced offset, or displacement, between the input line of travel and the corresponding output line of travel in the forward direction of the isolator.

### SUMMARY OF THE INVENTION

According to the invention, there is provided a multi-stage optical isolator having at least two stages, each stage comprising two birefringent wedge polarizers and a rotator therebetween. More specifically, the first stage comprises a first birefringent wedge polarizer for splitting an input beam into two orthogonally polarized sub-beams or rays (o-ray and e-ray), a first rotating means coupled to receive the sub-beams for rotating the polarization of the sub-beams, and a second birefringent wedge polarizer disposed in the optical path of sub-beams from the first rotating means. The second stage comprises a third birefringent wedge polarizer disposed in the optical path of beams from the second polarizer, a second rotating means disposed for receiving the beams for rotating the polarization of beams received from the third polarizer, and a fourth birefringent wedge polarizer disposed in the optical path of beams from the second rotating means. The input beam defines an input line of travel and light outputted from the fourth polarizer defines an output line of travel in a forward direction. In accordance with the invention, the wedge polarizers of the second stage are disposed such that the wedges, defined by their corresponding angles, of the third and fourth polarizer are arranged generally oppositely relative to the wedges of the first and second polarizer respectively, the angles of incidence in the forward direction and the wedge angles selected such as to minimize offset between the input line of travel and the output line of travel.

In one embodiment of the invention, the optical axes of the first and fourth polarizers are of substantially the same magnitude and identically oriented and the optical axes of the second and third polarizers are of substantially the same magnitude and identically oriented.

In one embodiment of the invention, the optical axes of the crystals forming the first, second, third and fourth polarizer are the same.

In one embodiment of the invention, the angle of incidence of the input beam on the first polarizer is of opposite sign relative to the angle of incidence of any light beam incident on the third polarizer in the forward direction.

The optical isolator may have more than two stages, always an even number, to compensate for the beam displacement, with the arrangement of each pair of stages and angles of incidence following the same relationship to the preceding stage as the above-described relationship. Specifically, the third stage would be arranged relative to the second stage such that the wedge angles of the polarizers of the third stage would be disposed at 180⁰ relative to the wedge angles of the second stage and so on. The same principle would apply to the angles of incidence.

In one embodiment of the invention, a PMD compensation element is disposed between the stages in the optical path of beams propagating between the stages. The element may be a birefringent plate, the thickness and optical properties of the plate selected to minimize polarization mode dispersion.

The provision of the PMD compensation element allows, in some embodiments of the invention, for the wedges of the first and the second stage of the isolator to be identical, meaning that the wedges are all cut with their optical axis at the same angle to a geometrical axis of the polarizer.

In one embodiment of the invention, the rotating elements are non-reciprocal rotating elements, for example Faraday rotators. The direction of the magnetic field of the Faraday rotators and thus the sign of rotation is selected to match the optical axis orientation of the wedge polarizers.

In one embodiment of the invention, a reciprocal rotating element, e.g. a half wave plate may be disposed in the optical path of the isolator.

It will be understood that when an element such as a layer, region or substrate is referred to as being “on”, “connected to” or “coupled to” another element, it can be directly on, directly connected to or directly coupled to the other element, or intervening elements also may be present. In contrast, when an element is referred to as being “directly on”, “directly connected to” or “directly coupled to” another element, there are no intervening elements present.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

### BRIEF DESCRIPTION OF THE DRAWINGS

Exemplary embodiments of the invention will now be described in more detail in conjunction with the drawings in which:

FIG. 1 illustrates a side view of main elements of a prior art two-stage optical isolator,

FIG. 2a is a side view of one embodiment of a dual-stage isolator of the invention, showing a forward path of light rays through the isolator,

FIG. 2b is a side view corresponding to FIG. 2a showing a backward path of light rays through the isolator,

FIG. 3a is a side view of another embodiment of the dual-stage isolator, showing a forward path of light rays through the isolator,

FIG. 3b is a side view corresponding to FIG. 3a showing a backward path of light rays through the isolator, and

FIGS. 4a and 4b illustrate a forward and backward path, respectively, of light rays propagating through another embodiment of the isolator.

### DETAILED DESCRIPTION OF THE EMBODIMENTS OF THE INVENTION

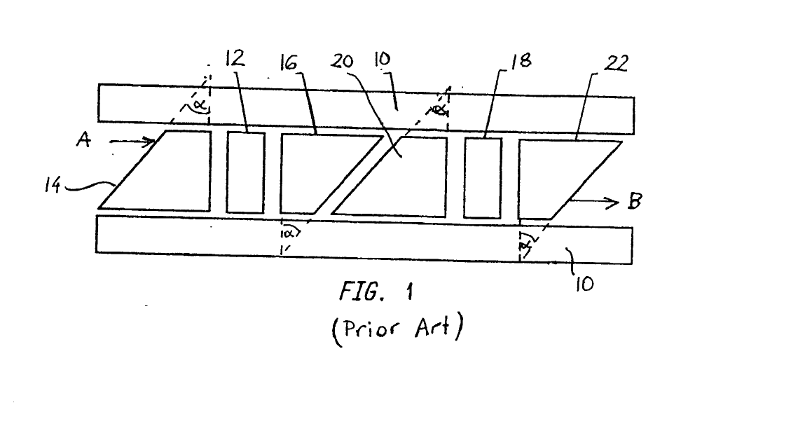

As seen in FIG. 1, a prior art isolator described in U.S. Pat. No. 5,581,640, the disclosure of which is incorporated herein by reference, has a magnet 10 holding a Faraday rotator 12 and polarizers 14, 16 of the first stage, and the Faraday rotator 18 and polarizers 20, 22 of the second stage. The wedges are manufactured of LiNbO₃, but another birefringent transparent material may be used. Secondary optical elements (lenses etc) are omitted for clarity. As illustrated, the wedges of the second stage look similar as the wedges of the second stage, i.e. the acute wedge angles α, of about 12⁰, defined by the sides of the wedge in cross-section (dashed lines), are disposed similarly in the first stage and the second stage. Specifically, the wedge angles of the first polarizer 14 and the third polarizer 20 are both directed upwards (in the drawing) and the wedge angles of the second polarizer 16 and the fourth polarizer 22 are directed downwards.

In order for the isolator to function satisfactorily, polarization mode dispersion is controlled by a selected optical structure of the prior art isolator. As illustrated and described in the '640 patent, the birefringent crystals are cut in such manner that the optical axes of the first and third polarizer are disposed at different angles (22.5⁰ and 67.5⁰, respectively, to the horizontal axis of symmetry), and the same applies to the birefringent crystals of the second and fourth polarizer respectively. As a result, at least two different crystal forms must be provided to design the prior art isolator.

As will be recognized by those versed in the art, an optical beam entering the first stage in a forward direction (arrow A), undergoes a separation into an o-ray and e-ray due to the birefringence of the crystal 14, and both these rays undergo a displacement relative to the direction A as they travel through the elements 12, 16, 20, 18 and 22. The displacement is a sum of the displacement encountered by the rays in the first stage and the second stage. The output beam (arrow B) is therefore shifted, or displaced, “downwards” relative to the input direction A. In other words, the input line of travel A is significantly displaced relative to the output line of travel and vice versa. For detailed propagation of rays in the design of FIG. 1, the specification of the '640 patent can be consulted.

It should noted that the design of FIG. 1 affords some dispersion compensation due to the selection of the optical axes of polarizers of the first and second stage, as described in U.S. Pat. No. 5,581,640.

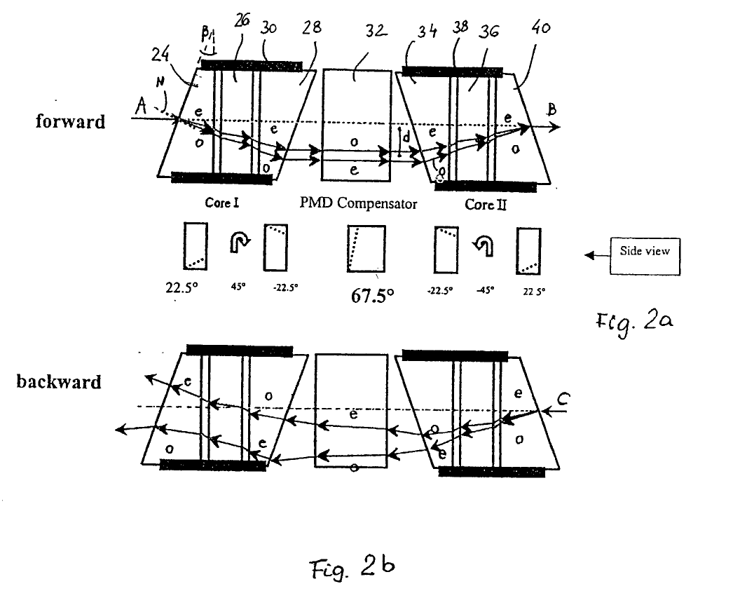

Turning now to FIGS. 2a and 2b, an exemplary isolator of the invention has a first stage with a first polarizer 24, a first Faraday rotator 26 and a second polarizer 28, held in a magnet 30. A transparent birefringent polarization mode dispersion plate 32 is disposed between the first stage and a second stage featuring a third polarizer 34, a second Faraday rotator 36 controlled by a magnet 38, and a fourth polarizer 40. It will be seen that the first polarizer 24 is disposed so that the wedge angle β is at the top of the polarizer, analogously to fourth polarizer 40; and the wedge angles of second and third polarizers 28, 34 are at the bottom. This is in clear variance to the arrangement of FIG. 1.

Optical characteristics of the elements of FIG. 2a are indicated at the bottom of the figure. This arrangement employs two types of polarizers. The polarizer 24 for the first stage of the isolator and the fourth polarizer 40 have the angles of their optical axes at 22.5⁰ and the second and third polarizers have their optical axes at −22.5⁰. The birefringent crystals are cut in such manner that the optical axes of the first/second and third/fourth polarizer are disposed at different angles (22.5⁰ and −22.5⁰, respectively, to the horizontal axis of symmetry). Note in FIG. 2a (side view) that the input light is decomposed into o-ray (22.5) and e-ray (22.5+90). The Faraday rotator rotates the polarization states by 45 degrees clockwise to −22.5 for the o-ray and −22.5+90 for the e-ray. The second polarizer with it optical axes oriented at −22.5 will change the direction of propagation of the o-ray back to the same direction at the input light. Similarly, the e-ray will also change back to the same direction as that of the input light. Only a very small displacement on the order of a few μm is created between the forward propagated o-ray and e-ray. In a typical single mode fiber isolator the beam diameter of the forward propagated beam is on the order of 400 μm (0.1 NA, 2 mm focal length lens), and such small displacement, on the order of a few μm will only generate a small PDL. Both o-ray and e-ray can be focused back to the output single mode fiber by the output fiber collimator. (For example for 10 μm separation, the maximum PDL that will be generated is only 0.01 dB). In practice, one can minimize the PDL by positioning the output collimator between the two forward propagating beams.

The third polarizer 34 with its optical axis selected at −22.5, will allow the o-ray to enter the third wedge as o-ray, and e-ray as e-ray. The optical axis of the forth wedge 40 is at 22.5 degree. This means that the Faraday rotator 36 has to provide a counter clockwise rotation of 45 degree to allow the o-ray remain as o-ray as it passes through the forth polarizer wedge 40, similar for that of the e-ray. Note that because of the wedge arrangement according to the invention, not only is the spatial displacement of the two forward propagated beams corrected to be the same as the input beam, but the small spatial separation of a few μm between them will also be reduced to zero. This means the PDL created by the first core has been cancelled by the second core. This is different from that of Pan's patent '640, supra. In that patent the spatial displacement of the propagating beams will double after two stages, and PDL will increase by a factor of 4.

In the present invention, the trade-off in obtaining this small PDL and zero beam displacement dual stage isolator core arrangement is that the PMD for this design is not self-compensated. This means that a PMD crystal has to be added to the dual stage core arrangement to compensate the PMD that was generated by the first and second isolator core. The location of this PMD compensation crystal is not important. In FIGS. 2a and 2b the PMD crystal 32 is placed between the first and second core. Specifically, the third polarizer's orientation is produced by rotating the first polarizer 24 by 180⁰, and the fourth polarizer 40 is similarly oriented relative to the second polarizer 28. However, it is not necessary that the relationship be exactly 180⁰, as will be demonstrated below, and a different angular relationship can be compensated with incidence angle.) The angles of rotation of Faraday rotators in the first and the second stage are of opposite sign (45⁰ and −45⁰) to match the optical axis orientations of the wedges of the first and second stage.

The input beam, incident on polarizer 24 at an input port defined by the arrow A, undergoes separation into e-ray and o-ray (letters “e” and “o”). As illustrated, both these rays undergo a refraction in the same direction resulting, as also explained in U.S. Pat. No. 5,581,640, in a downward displacement of the e-ray and o-ray leaving the first stage (the second polarizer 28) in parallel at a distance to each other, so-called walk-off. The provision of the birefringent PMD compensation plate 32 serves to slow down the e-ray thus providing dispersion compensation. The optical properties of the plate 32 are selected in a manner known to those skilled in the art, for example from U.S. Pat. No. 5,557,692.

After passing through the PMD compensator 32, the sub-beams e and o impinge on the third polarizer 34 of the second stage of the isolator. It will be seen that, due to the reversal of the wedge angles in the second stage compared to the first stage, the incidence angle of the rays onto the third polarizer is approximately the inverse of the incidence angle (defined by the arrow A and a normal to the input face of the polarizer 24) at the first polarizer. If, for example, the incidence angle at the polarizer 24 is expressed as −β (equal to the wedge angle and below the normal N to input face of the polarizer 24), then the incidence angle at the third polarizer is β (above the normal to the input face of polarizer 34). Of course, the input faces are considered here in the forward direction.

Due to the above-discussed arrangement of the polarizers and the angles of incidence, the (downwards) displacement of the sub-beams (e and o) relative to the line of propagation of input beam A in the forward direction becomes compensated with the result that the e-ray and o-ray undergo “upward” refraction and, as a result of optical properties of the elements of the second stage, merge into an input beam B. Through a careful selection of the optical properties and dimensions of all the elements of the isolator, the e-ray and o-ray can be brought into essentially a single beam which is highly advantageous for eventual focusing purposes.

As can be seen, the average vertical displacement d of the rays relative to the input beam propagation direction is virtually identical in the second stage as in the first stage but of opposite direction, such that the output beam B is virtually in line with the input beam A. This is due to the specific design of the embodiment of FIGS. 2a and 2b wherein the wedges are identical and disposed in a mirror-symmetrical arrangement as explained above.

The wedge polishing direction of the second stage polarizers is different than the polishing direction in stage 1 so that the optical axis of the first polarizer 24 of the first stage has the same orientation (22.5⁰) as the optical axis of the second polarizer 40 of the second stage. This enables high isolation of the sub-beams in the reverse direction (FIG. 2b).

In the backward direction, as well recognized by those skilled in the art and schematically illustrated in FIG. 2b, the return beam C undergoes a separation into an e-ray and o-ray which, due to optical properties of the elements and the phenomena well known in the field, pass through the second stage and the first stage significantly diverted from the forward line of travel (propagation) A, thus providing the isolating effect. It should be noted that the above described optical properties of the elements of the isolator of the invention are selected such that the e-ray and o-ray exiting the isolator in the backward direction (on the left-hand side of FIG. 2b) are divergent to each other, not parallel.

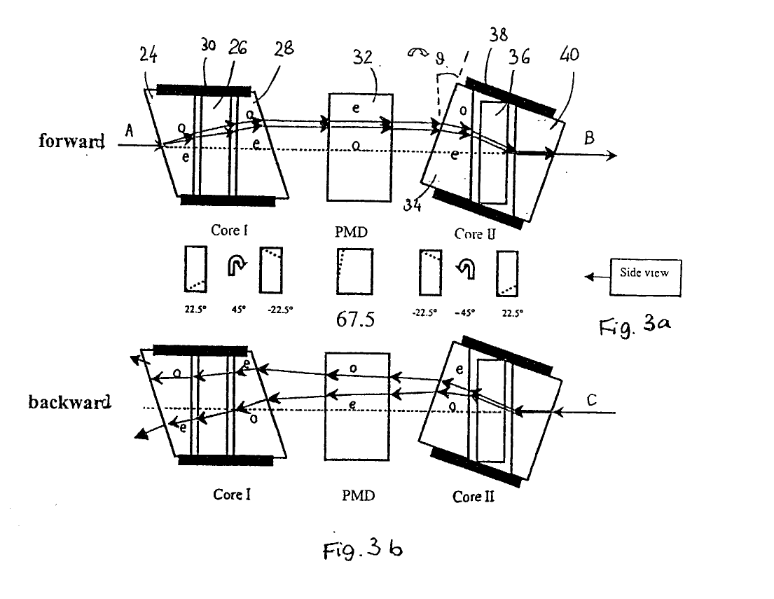

Turning now to FIGS. 3a and 3b, the working principle in the same as that of FIGS. 2a and 2b. Instead of using a different cut wedge the first wedge is flipped over and rotated to provide the same effect as that of the third wedge in FIG. 2a.

In the arrangement of FIGS. 3a and 3b, the mirror symmetry of the wedge polarizers is not maintained. It can be seen that while the right angle of the polarizer 24 as illustrated is directed towards the middle of the first stage, or in other words, the wedge 24 is an “outer wedge”, and the same applies to the second polarizer 28 of the first stage, the wedges 34, 40 of the second stage have their right angles directed outwards (“inner wedges”). The Faraday rotator 36 of the second stage is disposed between the wedges 34, 40 and in contact therewith, similarly as in the other embodiments. In order for the average vertical displacement d of e-ray and o-ray in the second stage to match the displacement caused by the first stage, the angle of incidence at the third polarizer 34 (in the forward direction, FIG. 3a) should match the angle of incidence on the first polarizer 24. As can be seen the second stage assembly 34, 36, 38, 40 is tilted clockwise by an angle ν (similar to the angle of incidence on the first polarizer) relative to its geometrical axis defined by the magnet 38 such that the above-noted angles of incidence are again essentially even but of opposite sign. However, the wedge angles β (see FIGS. 2a and 2b) meet the same condition as in the embodiment of FIG. 2a, i.e. the wedge angles or first and third polarizer are reversed and so are wedge angles of second and fourth polarizer.

It will be seen at the bottom of FIG. 3a, the optical axes of all the wedges are similar and the signs are opposite only because of the reversal of the wedges as described and illustrated herein. Again, this allows for the use of identically-cut wedges which is beneficial for manufacturing purposes.

It can be seen in FIG. 3a that the vertical displacement of the beams after the first stage is corrected in the second stage so that the input line of propagation A is virtually in line with the output propagation line B.

FIG. 3b illustrates a backward propagation of rays of light of a return light beam C. It can be seen that a satisfactory isolation is attained after two stages, the isolation of the second stage and the first stage adding up.

The magnetic field is reversed in the second stage relative to the first stage to match the optical axis orientations in all the polarizers.

Again, the wedge polishing direction of the second stage is different than the polishing direction of the first stage so that the optical axis of the first polarizer 24 of the first stage has the same orientation (22.5⁰) as the optical axis of the second polarizer 40 of the second stage. This enables high isolation of the sub-beams in the reverse direction. In this case all four wedges are made from the same cut and polished LiNbO3. The third and fourth wedge are mounted in the manner illustrated in FIGS. 3a and 3b to produce the effect of the third and fourth wedge in FIGS. 2a and 2b.

As in FIG. 2a and 2b, a PMD compensating birefringent plate 32, with optical axis oriented at 67.5⁰ is provided between the first and second stage in the embodiment of FIG. 3a and 3b, the properties (e.g. thickness) of the plate 32 selected to compensate for the dispersion between the orthogonally polarized sub-beams of the input light beam caused by the polarizers.

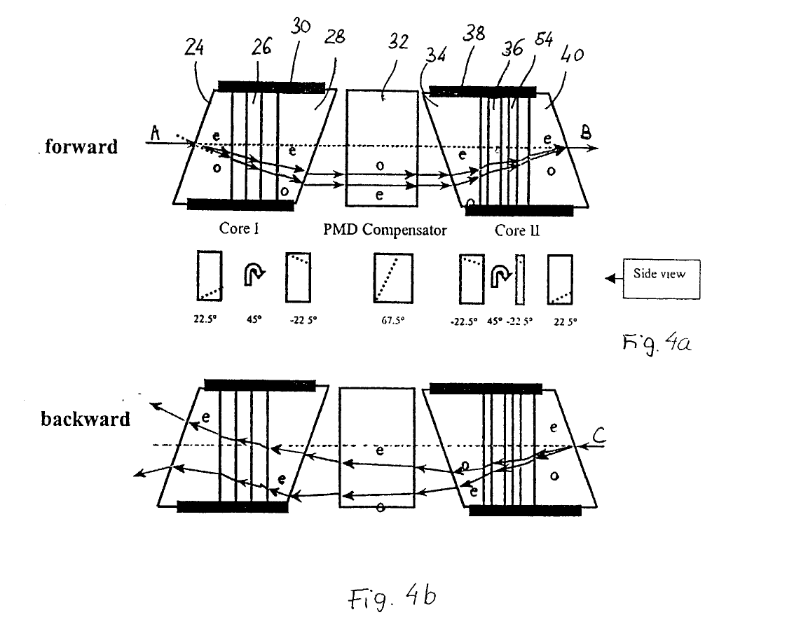

The arrangement of FIG. 4a represents another embodiment of the invention. Here, the polarizers are again disposed with the same wedge angle relationship as in the previously discussed embodiments. The wedges are all “outer wedges”. A half-wave plate 54 is provided between the Faraday rotator 36 and the fourth polarizer 40. The provision of the plate 54, a reciprocal rotator, with its optical axis at −22.5⁰ as seen at the bottom of FIG. 5a, allows for the same magnetic field direction for both Faraday rotators 26, 36 in both stages, as opposed to the embodiment of FIG. 2a.

The wedge polishing direction in this embodiment is the same as in the embodiment of FIGS. 2a and 3a, whereby the orientation of the optical axis of the first polarizer is the same as the orientation of the optical axis of the fourth polarizer. This allows for satisfactory isolation of the two beams in the reverse direction.

As illustrated in FIG. 4b, the arrangement of FIG. 4a allows for a satisfactory isolation in two stages, the separation of each stage adding up in the backward direction.

It will be noted that the structures of the present invention do not present themselves by simply rotating the second stage of the Pan '640 patent by 180 degrees around the propagation axis. Such rotation would result in a loss of isolation.

Various alternatives, modifications and equivalents of the embodiments herein described and illustrated may occur to those versed in the art, and the above description should not be taken as limiting in scope of the invention which is defined by the appended claims.

1. A multi-stage optical isolator having at least two stages, each stage comprising two birefringent wedge polarizers and a rotator therebetween,
the first stage comprising a first birefringent wedge polarizer for splitting an input beam into two orthogonally polarized sub-beams, a first rotating means for rotating the polarization of the two sub-beams received from the first polarizer and a second birefringent wedge polarizer disposed in the optical path of the sub-beams from the first rotating means,
the second stage comprising a third birefringent wedge polarizer disposed in the optical path of beams from the second polarizer, a second rotating means for rotating the polarization of received from the third polarizer, and a fourth birefringent wedge polarizer disposed in the optical path of beams from the second rotating means,
the input beam defining an input line of travel and light output from the fourth polarizer defining an output line of travel in a forward direction,
wherein the wedge polarizers of the second stage are disposed such that the wedges of the third and fourth polarizer are arranged generally opposite relative to the wedges of the first and second polarizer respectively, and the angles of incidence in the forward direction and the wedge angles selected such as to minimize offset between the input line of travel and the output line of travel.

2. The multi-stage optical isolator of claim 1, wherein the angle of incidence of the input beam on the first polarizer is of opposite sign relative to the angle of incidence of any light beam incident on the third polarizer in the forward direction.

3. The multi-stage optical isolator of claim 1 having an even number of stages, more than two, the arrangement of a second and any subsequent pair of stages and the respective angles of incidence following the same relationship to the preceding stage as in said first and second stage.

4. The multi-stage isolator of claim 1 comprising a PMD compensation element disposed between the first and the second stages in the optical path of beams propagating between said stages, the properties of the element selected to minimize polarization mode dispersion of light beams propagating through the isolator.

5. The isolator of claim 4 wherein the optical axes of the first and fourth polarizers are of substantially the same magnitude and identically oriented and the optical axes of the second and third polarizers are of substantially the same magnitude and identically oriented.

6. The isolator of claim 4 where the optical axes of the crystals forming the first, second, third and fourth polarizer are the same.

7. The isolator of claim 1 wherein the rotating elements are Faraday rotators controlled each by a magnetic field, the direction of the magnetic field for the Faraday rotators selected to correspond to the optical axis orientation of the wedge polarizers for recombining the two sub-beams in the forward directions and separating the sub-beams in the reverse direction.

8. The isolator of claim 1 further comprising a reciprocal rotating element disposed in the optical path of the sub-beams between the polarizers of the second stage and selected for allowing magnetic field direction for the first stage Faraday rotator and the second stage Faraday rotator to be the same.
